(19) United States
(12) Patent Application Publication
(10) Pub. No.: US 2007/0255526 A1
(43) Pub. Date: Nov. 1, 2007

(54) Method for Updating the Present time, Apparatus Using the Method and Memory to Implement the Method

(75) Inventor: Arnaud Rosay, Voivre les Le Mans (FR)

Correspondence Address: NXP, B.V.;NXP INTELLECTUAL PROPERTY DEPARTMENT, M/S41-SJ, 1109 MCKAY DRIVE, SAN JOSE, CA, 95131, US

(73) Assignee: Koninklijke Philips Electronics N.V., Eindhoven (NL)

(21) Appl. No.: 11/630,854

(22) PCT Filed: Jun. 20, 2005
(86) PCT No.: PCT/IB05/52018

§ 371 Date: Dec. 22, 2006

(30) Foreign Application Priority Data
Jun. 23, 2004 (EP) 04300390.4

(51) Int. Cl. G04F 5/00

(52) U.S. Cl. 702/178

(57) ABSTRACT

The method for updating the present time of a telecommunication apparatus using a TDMA (Time Division Multiple Access) technique to communicate with another device, comprises a step (76) of determining a new present time by using a count of a number of TDMA frames received since a starting time.

### FIELD OF THE INVENTION

The present invention relates to a method for updating the present time, an apparatus using the method and a memory to implement the method.

### BACKGROUND OF THE INVENTION

Known mobile phones have a timer to compute a present time that is generally indicated in a display unit. When a mobile phone is used for the first time, the user initially sets the present time of the timer. Then the present time is automatically updated using a real time clock (RTC) in the mobile phone.

Using a real time clock to automatically update the present time of the mobile phone may be an unsatisfactory method in cases where the power of the mobile phone is low. In fact, when the power of the mobile phone is out or very low, the real time clock is disabled and the present time is no longer updated. Consequently, the present time is incorrect when the power is restored.

An example of such a mobile phone is, for example, disclosed in U.S. Pat. No. 6,282,431.

### SUMMARY OF THE INVENTION

Accordingly, it is an object of the invention to provide a method for updating the present time of a phone which works even if the real time clock of the phone is disabled.

With the above and other objects in view there is provided in accordance with the invention a method for updating the present time of a telecommunication apparatus comprising the step of determining a new present time by using a count of a number of TDMA frames received since a starting time.

Each TDMA frame has a fixed time duration. Therefore, the count of TDMA frames received from a starting time is a measure of the time elapsed since the starting time. Hence, counting the number of received TDMA frames updates the present time without using the real time clock of the mobile phone.

The features of claims 2 through 4 improve the reliability of the method in situations where the power has been cut off.

The features recited in claim 5 count the number of received TDMA frames during a switched-off state of the telecommunication apparatus.

The invention further relates to a memory including the necessary instructions to execute the claimed methods as well as a telecommunication apparatus adapted to carry them out.

### BRIEF DESCRIPTION OF THE DRAWINGS

FIG. 1 is a schematic diagram of a mobile phone; and

FIG. 2 is a flowchart of a method for updating the present time of the mobile phone of FIG. 1.

### DESCRIPTION OF THE PREFERRED EMBODIMENTS

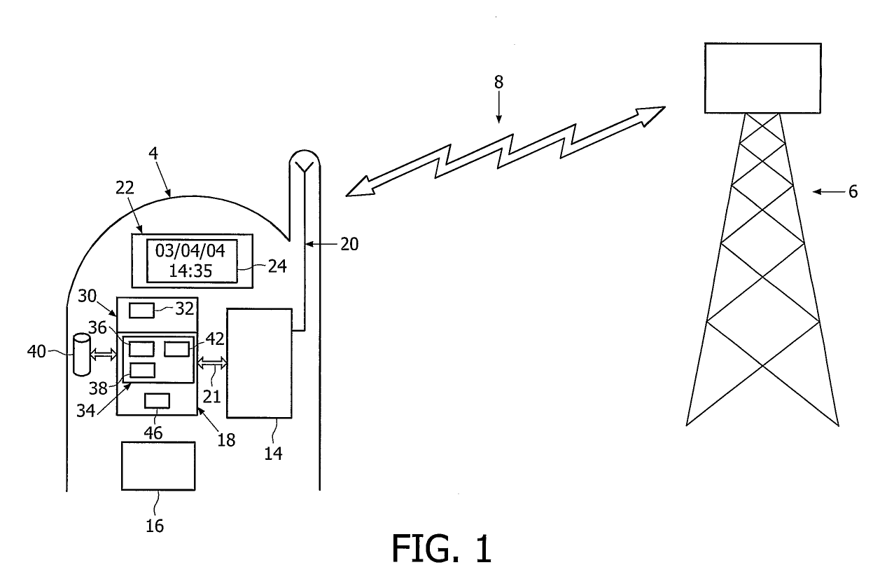

FIG. 1 shows a part of a radio telecommunication apparatus 4. As illustrated, the radio telecommunication apparatus is a GSM radio cellular mobile phone 4. Phone 4 communicates with a base station 6 of a radio cellular telephone network using radio signals 8. In order to do so, phone 4 implements a TDMA (Time Division Multiple Access) technique where time is sliced into TDMA frames, each TDMA frame corresponding to a predetermined time duration of, for instance, 4.615 ms. Hereinafter, a TDMA frame is referred to as a “frame”.

In GSM networks, 2,048 consecutive frames form a multi-frame. Fifty one (51) consecutive multi-frames form a super-frame and twenty six (26) super-frames form a hyper-frame. Each frame within a hyper-frame has an identifier which identifies the position of this frame within the hyper-frame. For example, this identifier is an integer number from 1 to 2715648, where 1 corresponds to the first frame and 2715648 corresponds to the last frame of the hyper-frame. A hyper-frame lasts about 3 h, 28 min. and 53 s.

Base station 6 is equipped with a transmitter and a receiver to transmit and receive radio signals 8 to/from phone 4.

FIG. 1 shows only the details necessary to understand the invention.

Phone 4 comprises a tunable radio transceiver 14, a power supply unit 16, and a baseband processor 18 to transmit or receive such radio signals.

Transceiver 14 is connected to an antenna 20 to transmit or receive radio signals.

Transceiver 14 is able to convert a received radio signal into a baseband signal or vice-versa. In other words, the main task of transceiver 14 is to remove a carrier from the radio signal or to add such a carrier to a baseband signal.

Baseband signals are exchanged between processor 18 and transceiver 14 through a line 21 connecting transceiver 14 to processor 18.

Power supply unit 16 is adapted to supply power to every electronic component of phone 4 such as transceiver 14 and processor 18. Typically, for mobile phones, power supply unit 16 comprises a rechargeable battery.

Phone 4 also comprises a display 22 on which the present time 24 may be displayed. As an illustration, the present time 24 comprises the present date and hour.

Phone 4 comprises a conventional timer 30 to update the present time which is displayed. To this end, timer 30 comprises a real time clock 32. Clock 32 is powered by unit 16.

Phone 4 also comprises a present time updating module 34 that updates the present time even if clock 32 is disabled.

Module 34 has a unit 36 that notes the number of the frames currently received, a recording unit or recorder 38 that records the present time and the number of a received frame in a memory 40, and a counter 42 that counts the number of received frames since a starting time.

Module 34 is associated with a checking module 46 designed to check the operating state of clock 32 to detect if the real time clock has been enabled.

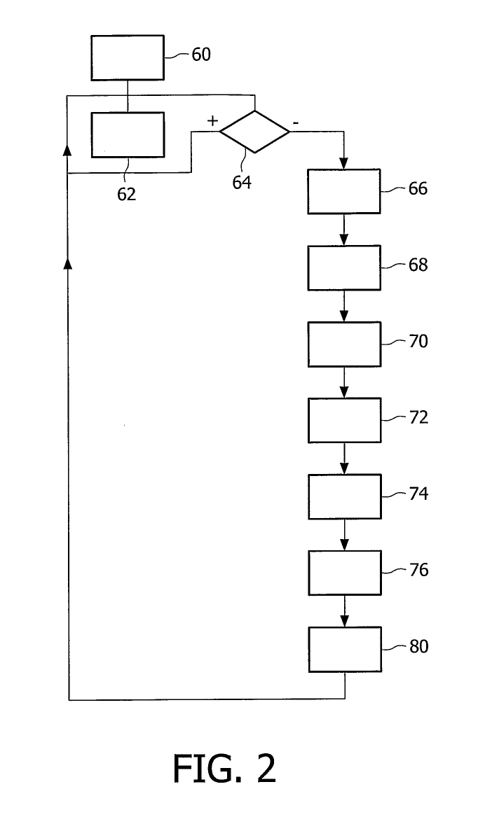

Modules 34 and 46 will be described in more detail with reference to FIG. 2.

Processor 18 is implemented with a programmable calculator capable of executing instructions recorded in memory 40, for example. Therefore, memory 40 includes the instructions for executing the method of FIG. 2 when such instructions are executed by processor 18.

For example, modules 34 and 46 are implemented in processor 18.

The operation of phone 4 will now be described with reference to FIG. 2.

Initially, when the user uses phone 4 for the first time, he sets the present time of phone 4 in a conventional way, as in step 60. Then, in step 62, the present time is continuously updated by timer 30 using the data generated by clock 32.

In parallel to step 62, in a step 64 module 46 checks the operating state of clock 32. If clock 32 is enabled and operates correctly, the method returns to steps 62 and 64.

On the other hand, if during step 64, module 46 detects that clock 32 will be disabled, phone 4 proceeds to a step 66. For example, module 46 checks if the power supply voltage lies below a predetermined threshold to detect if clock 32 is to be disabled. If so, the power supply of phone 4 will be lost and clock 32 be disabled.

In step 66, unit 36 notes the number of the frame currently received and, in step 68, unit 38 records the noted number and the present time in memory 40 updated most recently.

Then, the power is lost and all the mobile phone components are disabled.

Subsequently, in step 70, when the power supply is restored, module 46 detects whether clock 32 has been enabled again. Then, in step 72, unit 36 notes the number of frames currently received.

Thereafter, in step 74, counter 42 counts the number of frames received since step 68. For instance, counter 42 subtracts the number recorded in step 68 from the number noted in step 72.

In step 76, module 34 determines the new present time from the count established in step 74. For example, module 34 uses the following relation:
T_{new}=T_{old}+c×ΔT

where:

T_{new} is the new present time,

T_{old} is the present time recorded during step 68,

“c” is the number of frames received since step 68, and

ΔT is a constant time interval equal to the time duration of one frame that is 4.615 ms.

Finally, in step 80, the new present time T_{new} replaces the current present time. After step 80, the method returns to steps 62 and 64. As a result, the new present time is automatically updated by timer 30 from this point onwards until the next power failure of phone 4.

Module 34 is able to update the present time without using a real time clock. Consequently, after a power failure, the user does not need to set a new present time, as he does in step 60.

One of the main advantages of this particular method is to automatically set the present time of a mobile phone after a period during which the real time clock has been disabled. The period when the real time clock is disabled should be less than the time duration of one hyper-frame. Moreover, in the particular embodiment described, the mobile phone should remain in the same GSM cell during the period when the real time clock is disabled.

Many additional embodiments are possible. For example, the present time and the current frame number can be recorded in memory 40 at regular time intervals. In such cases, module 46 may be omitted.

The embodiment has been described in the particular situation where the telecommunication apparatus is a mobile phone. However, the method for updating the present time can be implemented in all types of telecommunication apparatuses using a TDMA technique to communicate with another device like a base station.

The described embodiment can be adapted to update the present time even if the real time clock has been enabled or if the real time clock is omitted from the telecommunication apparatus.

1. A method for updating the present time of a telecommunication apparatus using a TDMA (Time Division Multiple Access) technique to communicate with another device, wherein the method comprises a step of determining a new present time by using a count of a number of TDMA frames received since a starting time.

2. The method of claim 1, wherein the method comprises a step of recording the starting time in a non-volatile memory.

3. The method according to claim 1 for a telecommunication apparatus further comprising a real time clock to update the present time when the real time clock has been enabled, wherein the method comprises a step of checking the operating state of the real time clock to detect if the real time clock has been enabled, and a step of recording the present time in the non-volatile memory to form the starting time upon detection of the real time clock that as been.

4. The method of claim 2 for a telecommunication apparatus further comprising a real time clock, wherein the method comprises a step of automatically recording the present time in the non-volatile memory to form the starting time at regular intervals.

5. The method according to claim 2 wherein the method comprises the steps of:
recording in the non-volatile memory a number of the TDMA frame received at the same time when the starting time is recorded,
at the time of determining the new present time using a count of the number of TDMA frames received since the starting time:
noting a TDMA frame number of the currently received frame, and
counting (the number of TDMA frames received since the starting time using the recorded TDMA frame number and the noted frame number.

6. A memory comprising instructions to execute a method according to claim 1, when the instructions are executed by a programmable calculator.

7. A telecommunication apparatus using a TDMA (Time Division Multiple Access) technique to communicate with another device, the apparatus comprising a module for updating a present time, wherein the module is adapted to determine a new present time using a count of a number of TDMA frames received since a starting time.

8. The apparatus of claim 7, wherein the apparatus comprises a non-volatile memory and a recorder to record the starting time in the non-volatile memory.

9. The apparatus according to claim 8, wherein the apparatus comprises a counter to establish the count of the number of TDMA frames received since the starting time using a number of a TDMA frame received at the same time when the starting time is recorded and a number of a TDMA frame received at the time of determining the new present time.

10. The apparatus according to claim 7, wherein the apparatus is a mobile phone.
